(19) United States
(12) Patent Application Publication
(10) Pub. No.: US 2015/0222008 A1
(43) Pub. Date: Aug. 6, 2015

(54) PERFORMANCE ENHANCING ELECTRONIC STEERABLE CASE ANTENNA EMPLOYING DIRECT OR WIRELESS COUPLING

(71) Applicant: Xi3, Inc., Salt Lake City, UT (US)

(72) Inventor: Henry Cooper, Temecula, CA (US)

(73) Assignee: Xi3, Inc., Salt Lake City, UT (US)

(21) Appl. No.: 14/414,442

(22) PCT Filed: Jul. 11, 2013
(86) PCT No.: PCT/US2013/050168

§ 371 Date: Jan. 12, 2015

Related U.S. Application Data
(60) Provisional application No. 61/670,537, filed on Jul. 11, 2012.

(51) Int. Cl. H01Q 1/24; H01Q 21/29

(52) U.S. Cl. CPC H01Q 1/243; H01Q 21/29

(57) ABSTRACT

A auxiliary antenna system is provided for a portable electronic device such as a smartphone or cellular phone or pad computer. The system positions one or a plurality of auxiliary antennas in or on walls of a protective case surrounding the electronic device. An internal antenna on the electronic device is communicated an RF signal of increased strengths and bandwidth from an auxiliary antenna coupled thereto. Additional auxiliary antennas may be positioned on the case to increase both signal and bandwidth.

This application claims priority to U.S. Provisional Patent Application Ser. No. 61/670,537, filed on Jul. 11, 2012.

### BACKGROUND OF THE INVENTION

1. Field of the Invention

The present invention relates to antennas for transmission and reception of radio frequency communications on portable cell phones and smartphones and pad computers and the like. More particularly the present invention relates to an auxiliary antenna built into a housing adapted to cover two or three sides of a smartphone or cell phone, which is configured to electronically connect one or a plurality of auxiliary antennas positioned on or within the case housing, with the built-in antenna of the smart phone or cell phone enhanced by the frequency reception and transmission of the electrically connected, surrounded case antenna or antennas.

2. Prior Art

Smartphones, cellphones, and other portable handheld electronic devices such as pad computers have become in recent years ever more popular for business and personal users. While typically in past years cellphones would operate on cell frequencies and might take photographs, the new breed of handheld devices have turned into hybrid devices which function as phones, web cameras, computers, web browsers, all in a single device. Smartphones, because of their hybrid nature and ability to function as a computer, camera, phone, broadcast station, router, and other functions, have become a predominant product in the area of hand held communications.

Because of their hybrid nature requiring smartphones and cellphones and the like to function in numerous capacities, wireless communication, by such devices, has seen the inclusion of many more frequencies on different broadcast bands than devices of the past. For example smartphones currently sold in 2012, will conventionally operate on multiple cellular phone bands and frequencies, on bluetooth frequencies, and on WiFi frequencies to enable the device to communicate for its diverse functions. Further, many such devices also function as base stations and routers for confections to other electronic devices in need of access to cellphone frequencies or the internet to communicate. Cellular telephones and other devices with cellular capabilities currently electronically communicate using cellular telephone bands at 850 MHZ, 900 MHZ, 1800 MHZ, and 1900 MHZ. Other frequencies can include WiFi bands at frequencies of 2.4 GHz and 5.0 GHz and the Bluetooth running at frequencies of 2.4 GHz. With the move of television to UHF, more frequencies are coming available for data and voice and other communication. Such frequencies may be accessible using a simple firmware upgrade, or may require a new phone. Finally, low earth satellite systems such as Iridium function in the satellite frequency range with handheld devices and it is envisioned such communication could be added to the abilities of smartphones and cellphones if antennas can be provided with sufficient gain to allow such communication.

While cellphones and especially smartphones, which function as hybrid multiple broadcast and receiving devices, are for all intensive purposes still portable and intended for carrying in pockets and purses. Consequently, a very small footprint is provided to position and employ antennas capable of broadcasting and receiving on the multiple noted frequencies and radio bands.

This small form factor is a major problem in providing proper sized antennas in proper positions, to receive and transmit with high gain and at the required frequencies for proper electronic communication adapted to the task required. The small form factor problem is exacerbated when the interference caused by the user's hand gripping the phone is included, and the use of metal cases to house many such smartphones and cellphones.

As a consequence, many such smartphones and cellphones do not function adequately on any, or some of the frequencies required to communicate for the various electronic tasks of such hybrid communications devices. Further, manufacturing errors, and design errors, venue and device positioning can all have a serious impact on proper electronic wireless communication by such smartphones and cellphones.

Additionally, existing smartphones and cellphones and pad computers, undoubtedly can be made capable of other functions such as functioning to receive off-air HDTV and normal TV signals, as well satellite phone frequencies, and other frequencies that such device can be enabled to communicate upon. Firmware updates and software enabled transmission and reception can surely enlarge current smartphones and pad abilities over time.

However, absent a manner to provide antennas of sufficient size and gain to provide the required broadcast and reception, in a direct or indirect electrical connection as needed, existing such smartphones and the like, will be unable to be upgraded with a simple firmware or software upgrade or “app” to use these enhanced capabilities.

In addition, the need to increase this operational frequency band width is also desirable for fast INTERNET, HDTV, and GPS and many other applications. This is due to the fact that the performance of the currently designed embedded antennas are limited to their sizes and locations and frequency band width and incoming signal directions and their environments. Therefore, the signal strength is very difficult to optimize to the desired level and band width is limited for other applications.

The solution to these problems is to use the disclosed electronically coupled enhanced or electronic steerable wideband case antenna to improve the transmit and receive signal strength and to provide additional frequency band width for other applications, through either coupling or direct contact, to excite their antennas' feed line and using delay line to steer its electronic beam to the desired direction to enhance their transmit and receive signal strength.

As a result, the quality of the wireless communication signal strength can be improved and performance enhanced through the coupling and employment of the disclosed case antennas herein in conjunction with existing and future smartphones, pad computers, and the like. Their exists an unmet and ever increasing need for a device and method to enhance the reception capability of conventional hybrid devices such as smartphones, cellular phones, pad computers and the like. Such a device should be adapted for easy, toolless engagement to the factory produced phone or smartphone casing. Such a device in such an engagement should provide an easy coupling of auxiliary antennas positioned on or in a form fitting casing, to the factory OEM antenna or antennas and provide enhanced reception and broadcast capabilities to the OEM device. Finally, such a device should be easily engaged to provide an interface to an existing smartphone or cellphone, PDA, or other portable wireless device, so as to provide an antenna capable of communicating over newly enabled frequencies for newly offered services, and thereby prolong the life of such devices.

### SUMMARY OF THE INVENTION

The device and method herein disclosed and described achieves the above-mentioned goals through the provision of a casing adapted to engage with an existing cellphone or smartphones or other handheld wireless device, which has antennas in or on the casing which will engage and electronically communicate with the electronic device to which the casing engages.

The proposed electronic steerable wide band case antenna is made of two identical wide band antenna elements and with a N-bit delay line beam forming network to steer the electronic beam to its desired direction to improve its signal strength, where N can be either 2, 3, or 4, depending on the beam steering resolution required.

The device is adapted to electrically contact and communicate with the built in existing OEM antenna at the base of a specific design smart phone, using a protective casing or engageable over-molding of rubber or plastic or other polymeric material adapted to the task. The casing or over-molding will also function as an aftermarket plastic or rubber housing, which once engaged over the underlying OEM smartphones, protects the smart phone from impacts and other dangers.

A coupling re-radiator element can be configured to enhance cellular band transmission and reception such as the GPRS signals of a smart phone as well as protect the smart phone from drops and environmental elements.

The device may be configured to directly or indirectly couple with, and thereafter enhance radio communications of any smartphones and the device would position coupling components in relation to OEM antennas, to provide the electronic coupling required. For instance employed in combination with a smartphones which has an outer metallic ring which functions as an antenna to radiate signals, the device employs a coupling re-radiator element which is embedded inside, or below the surface of a polymeric protective over-molding designed to also protect the smart phone. The coupling re-radiator is configured for better matching for impedance than the OEM antenna to thereby provide a means to receive weaker signals for which the OEM device is incapable or impaired.

Connection to the OEM device, of the radiator elements hosted in the over molding can be handled in at least two different coupling modes.

a. A Direct connection can be achieved, using the metal case of smart phone to connect to copper feed strip operatively positioned in the over molding.

b. A Capacitive coupling can be achieve for a transfer of energy from OEM radiator element to a coupled element hosted by the over-molding herein, thereby eliminating the need for a direct wired connection. This may be achieved by positioning the proper radiator elements adjacent to the RF field of the smartphones thereby coupling the smartphones antenna radiator element, to the auxiliary outer element embedded in polymeric material of the over-molding.

The auxiliary antennas hosted in or on the over molding, can be adjusted in size and position, to help alleviate the interference caused by poorly designed OEM devices, and the hand and head of a user operating the smartphones.

For a smartphones having an OEM antenna positioned at the base of the OEM phone housing, the device employs a conductive type patch positioned adjacent to the base of the smartphones. The conductive type patch acts as a feed to couple the OEM antenna of the phone, and the embedded coupled re-radiator element operatively positioned in or on the polymeric material of the over-molding which is sized to engage on the perimeter of the OEM smart phone.

The new embedded element, so coupled, is typically formed of a thin 1 mil thick flexible copper element configured to be tuned specifically to match and couple on an individualized model bases for each model of smartphones design for which the over-molding is adapted to engage upon.

The smart phone OEM built-in antenna element is typically 3:1 and 4:1 VSWR, in its original state. However, with the device herein having the over-molding case engaged to the OEM smartphones to achieve a coupling of the re-radiator operatively positioned in or on the over-molding element, the VSWR of the OEM smart phone will improve the VSWR performance to 2:1 to improve cellphone reception and transmission, such as the GPRS or CDMA frequency reception, especially in hard to reach weak signals areas. Additionally, the antenna formed in or on or attached to the case can be optimized for frequencies for which the OEM antenna is incapable and provide signals at those frequencies to allow the OEM phone or pad or device, to be upgraded to receive new bands or signals for new purposes. For instance an IPHONE might be enabled for low orbit satellite communication using the antenna herein described which is configured for low earth satellite communication for instance using a fold-down antenna coupled to the OEM antenna.

With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the pioneering conception of such a coupling of a case or over-molding housed antenna on which this disclosure is based, may readily be utilized as a basis for designing of other antenna structures, methods and systems for carrying out the several purposes of the present disclosed device. It is important, therefore, that the claims be regarded as including such equivalent construction and methodology insofar as they do not depart from the spirit and scope of the present invention.

It is one principal object of this invention to provide one or a plurality of auxiliary antenna radiator elements positioned in or on a casing or over-molding adapted to engage upon a smartphones, pad computer, or other computing device needed for communication, and to couple with an OEM antenna of the device to which the over-molding or case herein engages.

It is a further object of this invention, to enhance the reception and transmission capabilities of the smartphones or other device with which the over-molding engages on one or a plurality of bands and/or frequencies.

It is a further object to provide such an over-molding or case cover device, which can provide coupling to original smartphones or cellphones, for the communication over radio frequencies for which the engaged smartphones or similar device was not originally designed or enabled, such as any of the aforementioned frequencies and band, but which it may be upgraded to operate upon with firmware or software enhancements.

It is a further object of this invention, to provide a case for engaging a smartphone, pad computer, or similar device, which enhances communications on cellular telephone bands at 850 MHZ, 900 MHZ, 1800 MHZ, and 1900 MHZ, and provides enhancement on other frequencies such as WiFi bands at frequencies of 2.4 GHz and 5.0 GHz and the Bluetooth running at frequencies of 2.4 GHz, and which will allow use of such devices to receive off-air signals broadcast on HDTV bands, and from and to satellite systems such as Iridium.

These together with other objects and advantages which become subsequently apparent reside in the details of the construction and operation as more fully hereinafter described and claimed, reference being had to the accompanying drawings forming a part thereof, wherein like numerals refer to like parts throughout.

### BRIEF DESCRIPTION OF DRAWING FIGURES

FIG. 1 depicts one mode of the enhanced auxiliary antenna embedded into the polymeric material of two piece engageable polymeric protective case, or one piece case which is elastic, either of which are adapted to engage in a surrounding-communication with a smartphones such as an IPHONE, a DROID, or with a pad or tablet or other portable computing device. So engaged the device herein, provides enhanced transmission and/or reception, and/or operating bands for the electronic device.

As noted the device shown in FIG. 1, in a as-used configuration, sized to engage around the perimeter and front and rear faces of a portable computing device, or portable communication device such as a smartphones. The device 10 may be formed in a single component to yield the as-used configuration of FIG. 1 or may be formed of a plurality of engageable components.

FIG. 1a depicts a mode of the device 10 formed to an as-used configuration through the engagement of the two component pieces to form the device of FIG. 1 and concurrently engage around the perimeter of a smart phone in a registered engagement of the device cover antennas, with the internal antenna of the phone. In cases where the smartphones or portable devices have two antennas, which switch depending on the horizontally or vertical orientation of the phone or computing device, optionally a software or firmware upgrade is provided to deactivate the switch from one antenna to the other, when held by the user, so as to maintain the coupled communication of the OEM antenna with the antenna or antennas of the device herein.

FIG. 1a depicts two antennas situation on, or adjacent to the interior surface of the device in the as-used configuration, which situates them for a direct, or coupled engagement with the interior OEM antenna. Shown are a meander line antenna and a second differently configured meander line type antenna. The second antenna is shown with a leg situated to engage with an antenna contact point with the interior antenna such as with the IPHONE, to provide a direct electrical contact therewith. Other antennas on the interior surface of opposite surface are electrically coupled in a symbiotic engagement to communicate both transmission and reception on RF signals from and to the smartphones.

FIG. 2 is a top plan view of the protective case device herein, such as in FIG. 1. It depicts in dotted line another mode or shaped configuration of a coupled antenna in operative communication with the OEM antenna, similarly to that of FIG. 1.

FIG. 3 shows a side sectional view of a conventional smartphone such as an IPHONE having one or two internal antennas in the OEM smart phone casing. The depicted OEM antenna is provided by an outer metallic ring which radiates signals which is either directly contacted with one antenna herein, or placed in a coupled or symbiotic engagement. It is important to note, in all modes of the device herein, that the spacing of the antennas, alignment thereof, and dialectic material used in-between adjacent antennas may be changed to optimize the radiated and received RF signals by the phone or smart device. Current dielectrics are polymeric materials which include thousands of potential combinations of polymeric resins such as polyethylene, polyester, polypropylene, polystyrene, and any other polymeric material having or yielding the proper dialectic index.

FIG. 4 is a top plan view of a radiator element of the surrounding-case device herein showing a coaxial connector positioned in electronic engagement with the feed lines and adapted to engage mating connectors.

FIG. 5 depicts a side view of the front and rear components forming an as-used device. The device configured to surround three sides of a smartphones or pad computer or other portable device employing RF, may be formed of more than two components, such as with three where additional antennas may be coupled or directly engaged with each other to yield the improved transmission and reception of RF.

FIG. 6 depicts a side view of a possible as-used assembled mode of the smartphones or pad surrounding device showing a plurality of radiator elements, or a single or multiple sizes, engaged and vertically stacked.

FIG. 7 depicts a mode of the device having a case-mounted antenna which is configured to make a direct contact electrical communication with an antenna lead of the engaged smart phone or pad computer or smart device being encased, rather than by wireless symbiotic or capacitive engagement.

FIG. 8 depicts an assembled two-piece phone-surrounding case, showing an antenna element positioned on an interior surface where a direct or symbiotic wireless communication can be made with an internal phone antenna. It should be noted in all modes of the device herein, that the antennas employed may be on the surface, or positioned within the wall forming the surface and insulated by surrounding polymeric or other dialectic material. Either type of positioning is anticipated and in the scope of this invention.

FIG. 9 depicts a top-down view of the case device herein, showing an antenna element edge, configured for a direct contact engagement with an antenna lead or element from the engaged pad computer or smartphones to which it engages and surrounds.

FIG. 10 shows a rear side of a front panel of FIG. 9. As shown this component has an aperture which is sized and configured to contact the screen-side of a smart phone or pad or computer such as the IPHONE when operatively engaged in the as-used configuration.

FIG. 11 shows a bottom edge of a rear cover component engageable to form a two piece smartphone cover device. An antenna lead is positioned to directly contact with the rear of a smartphones and having an edge surface of a mounted antenna element configured and positioned for direct contact communication with the OEM antenna of a smartphones such as the IPHONE.

FIG. 12 depicts a mode of the device where an inner surface of a rear component which is positionable to abut the rear of the smartphones or pad, engages a front component as shown in FIG. 1a. Also shown are a plurality of antennas positioned on, or adjacent to the interior surface, in registered positions to yield electronic coupled or symbiotic communication with the phone OEM antenna. As noted above, one, or a plurality of the antennas, my be positioned within the wall surface of the front or rear component, or front or rear wall of a one-piece component, rather than on the surface. The one or plurality of antennas positioned on the device, are configured to yield the enhanced performance or increased bandwidth to the engaged smartphones or pad or portable RF using device, as well as to maintain a symbiotic or coupled electronic engagement with each other and/or also with the third antenna positioned on or within the wall surface forming the exterior surface shown in FIG. 13.

FIG. 13 depicts the opposite side surface, or exterior facing surface, of the rear component of the two-piece device, or rear wall of a unitary device, shown in FIGS. 12 and 1a, showing an additional antenna on or within the wall surface and thereto, and spaced by dialectic material from the internally positioned antennas by the dialectic material forming the rear component.

FIG. 14 depicts another view of the rear component of FIG. 12, or a rear wall of a unitary device, and showing the planes of positioning of the dialectic-separated internal and external antennas. The spacing filled with a dialectic of choice which helps achieve optimum symbiotic communication between the antennas on one plane and antennas on the adjacent parallel plane, as well as determining the spacing or distancing between them which may be adjusted. Also shown are vertical disposed planes calculated for optimum positioning of one antenna to communicate with internal phone antennas.

FIG. 15 is a side view of the device formed of two components as in FIG. 14, or formed of a front and rear-walled unitary structure showing planes of antenna location and registration relative to each other, calculated for maximum electronic communication between OEM phone mounted antennas and the rear component engaged antenna or antennas.

FIGS. 16-17 depict a plurality of antennas which may be placed in a stacked positioning, either within the wall of the surrounding cover, or upon the inner surface and within or on the outer surface of the rear wall of either a unitary smartphone or pad-surrounding device or the rear component which engages a front component as shown in FIGS. 1a, and 12. Shown are a plurality of antennas positioned on or adjacent to the interior surface, in registered positions. Included are a wideband antenna of FIG. 17 in a coupled engagement to the antenna of FIG. 16 in a symbiotic relation separated by a calculated width of a dialectic adapted to the task. In all wideband antennas herein, the lowest operating frequency is determined by the widest point between the declining sloping sides of the opposing lobes of the wideband antenna. The highest frequency is determined by the narrowest point of the slope. These may be adjusted to provide the frequencies desired. Of note on the depicted wideband of FIG. 17, is the slight declining slope at the opposing distal corners which was developed to enhance low frequency operation and is preferred over a continuing curve at the same incline.

FIG. 18 shows the exterior or rear surface of the rear component as in FIG. 13 and showing an omnidirectional wideband antenna thereon in communication through the dialectic material forming the rear of the component with one or a plurality of interior antennas as described herein in a stacked positioning and coupled engagement. As noted one or all of the antennas may be placed within the wall surface in a stacked, separated configuration adapted to yield the maximum coupled electronic communication of RF signals between them.

FIG. 18a depicts the opposite side of the coupled clover shaped antenna.

FIG. 19 depicts a flip-up member section configured with an omni directional antenna of FIG. 18, or with an antenna configured to communicate vertically and on frequencies of low earth orbit satellites. This addition to conventional smartphones or pad computer device provides the ability to operate on satellite communications channels of overhead low earth orbit satellites when coupled with a firmware or software upgrade to allow the device to synthesize such frequencies. In the same manner any of the antennas herein, or adapted modes thereof, may be configured to provide new frequencies of operation, or enhanced frequencies of operation of the smartphones or pad when coupled therewith in the as-used configuration.

### DETAILED DESCRIPTION OF THE PREFERRED EMBODIMENTS OF THE INVENTION

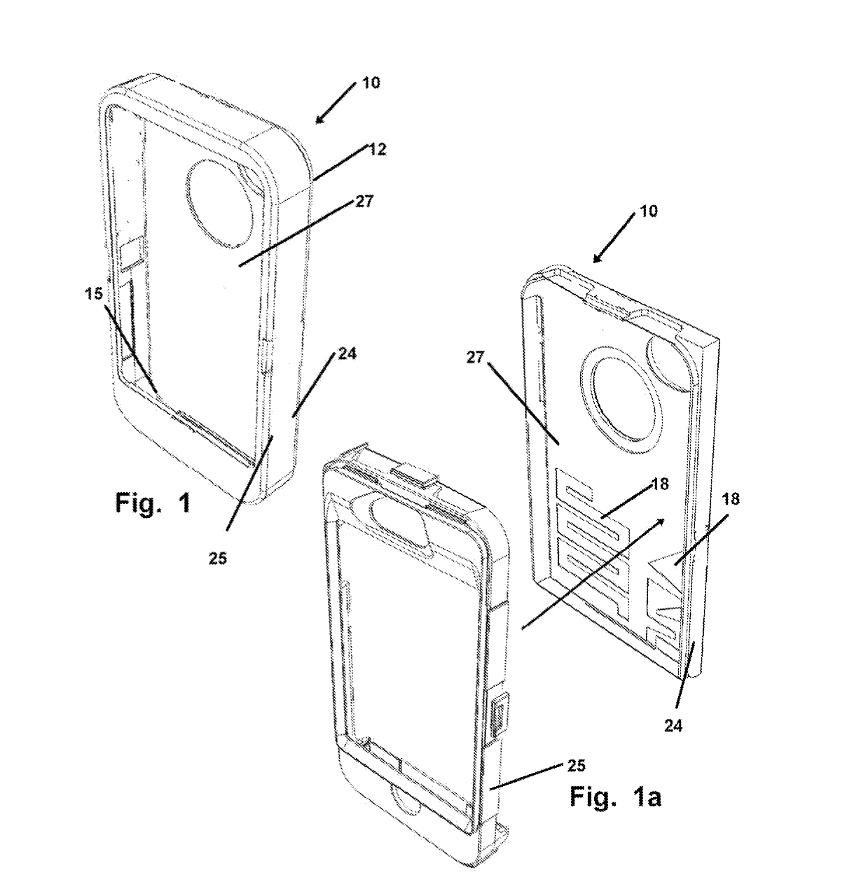

Now referring to drawings in FIGS. 1-19, wherein similar components are identified by like reference numerals. It should be noted that any of the antennas shown herein, may be situated and configured in a registered position with the internal smartphone or pad computer antennas, to operatively communicate with any one or plurality of other antennas of electronic devices enclosed, such that the computer or smartphones enjoys enhanced receipt and transmission of RF signals on a plurality of bands, and/or may be provided with added ability to communicate on other bands, or satellite bands, by a firmware and/or software upgrade and the appropriately configured vertically or horizontally disposed antenna. While direct connection is shown in a few drawings, electronic coupling by proper registered positioning of the multiple antennas works best.

Further, any one or plurality of antennas may be placed in a physical communication with interior OEM antennas of the smartphones or computer or pad, or may be placed in an electronic RF symbiotic or coupled engagement with the OEM antenna, and or one or a plurality of other properly situated antennas. As such any direct or coupled engagement of antennas to provide increased gain and/or increased frequency performance to the device to which they engage, as would be anticipated by one skilled in the art, is considered within the scope herein.

FIG. 1 depicts one mode of the device 10, with an assembled casing and having an enhanced auxiliary antenna, embedded into the plastic or polymeric material forming the two piece engageable polymeric protective casing 12. The interior of the casing 12 is dimensioned to fit in a surrounding or abutting communication with the exterior of a portable computing device or smartphone such as an IPHONE.

FIG. 1a depicts an engagement of the separated two component pieces of the case 12, to form the case 12 of the of FIG. 1 and concurrently engage an interior cavity 15 dimensioned to position around the side surfaces of a smart phone. The antennas 18 as shown, are positioned in or on the case 12 material in a fashion to register them in engagement with the transmitting antennas of the phone or computing device, in an electrically coupled engagement between RF signal from and to the internal antenna of the phone.

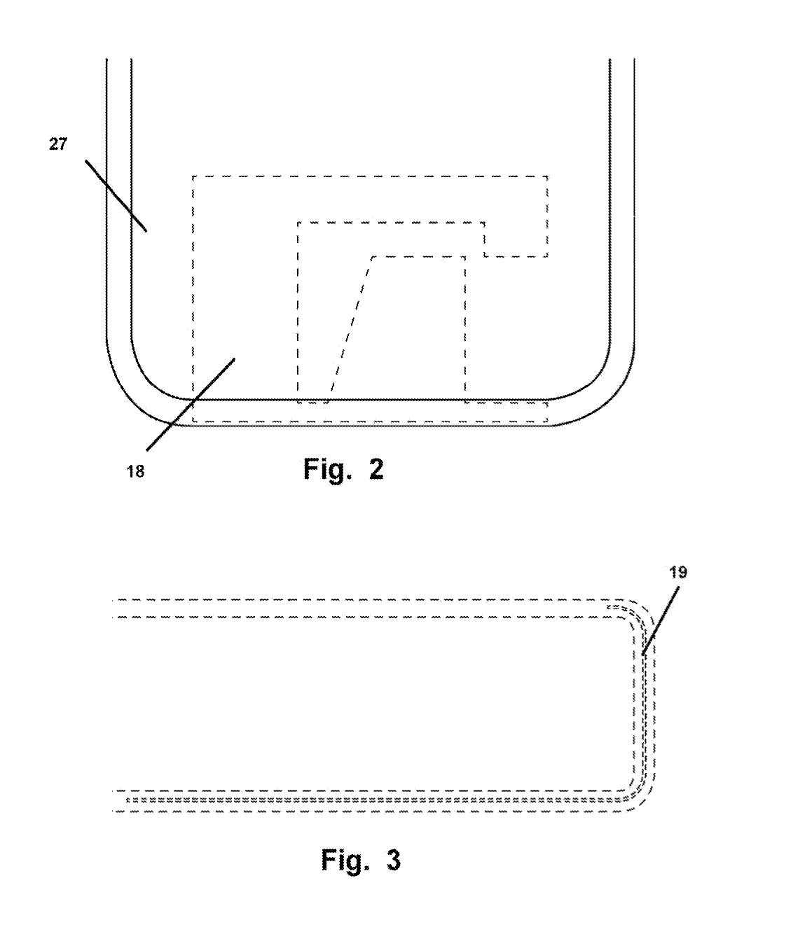

FIG. 2 is a top plan view of the protective case of FIG. 1 showing another mode of a coupled antenna operative similarly to that of FIG. 1, in dotted line.

FIG. 3 shows a side sectional view of a conventional smartphones such as an IPHONE having an internal antenna, 19 in the OEM smart phone base provided by an outer metallic ring which radiates signals.

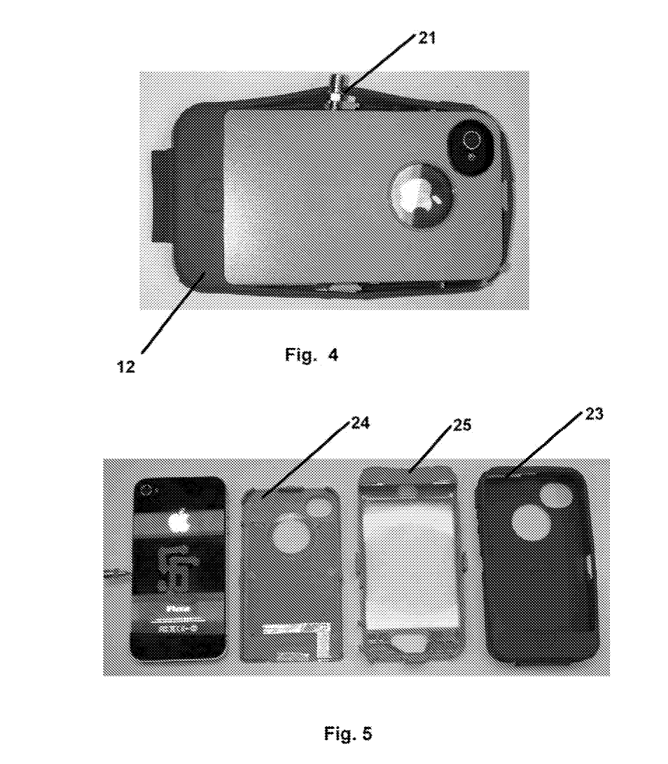

FIG. 4 is a top plan view of a case 12 bearing an antenna fitting 21 in operative coupled engagement with the antenna 18 in or on the case 12. The coaxial connector fitting 21 is positioned in electronic engagement with the feedlines from the antenna 18 or antennas 18 in or on the case 2, and adapted to engage mating connectors.

FIG. 5 depicts a side view of the device of FIG. 4, showing a disassembled case 12 and a flexible cover 23 for an elastic fit around the assembled case 12 to protect the radiator element or antenna 18 from abrasion if mounted on the back wall exterior of the assembled case 12.

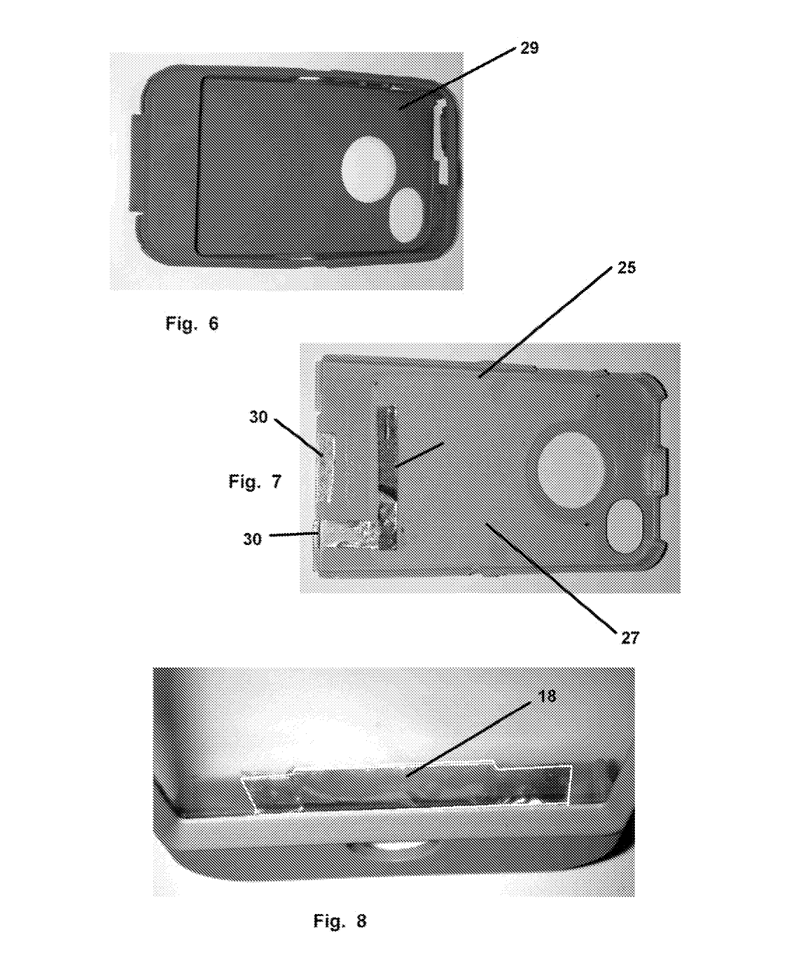

FIG. 6 depicts a side view of one preferred as-used configuration of the device 10 showing a backwall 29 of the rear portion of the case 12. Positioned within the backwall 29, in a layered spaced positioning, with dialectic material between each antenna 18, are a plurality of antenna elements in registered positioning to maintain an electrically or RF coupled engagement for transmission and signal receipt. As noted herein, the plurality of stacked antennas 18 may be single or multiple sizes, and are in a registered positioning relative to each other, and the antenna of the smartphone or pad computer, to maximize the RF signal send and received in the coupled engagement. Using the stacked configuration of multiple antennas 18 which are separated by dialectic material, beam forming of the RF signal from the smartphone or pad computer may be accomplished to maximize throughput and communication.

FIG. 7 depicts a mode of the device having an antenna mounted or positioned in an engagement to a sidewall of one component which engages a mating component for forming a device-surrounding case 12 for a smartphone or pad computer or other portable device. As depicted, the mounted antenna 18 has a vertical and horizontal lead 30 which is in a registered engagement on the case 12 component such that when the case 12 engages around the smartphone or pad or other device, the feedline 30 makes a direct contact communication with the antenna lead inside the case of the phone, rather than by an electrically coupled engagement, symbiotic engagement, or capacitive engagement, depending on the nomenclature used.

FIG. 8 depicts a section of an assembled two-piece phone-surrounding case 12, showing an antenna element on an interior surface thereof, in a position where either a direct or coupled wireless engagement can be achieved with a smartphone or pad having an interior antenna in a matching position, such as an IPHONE.

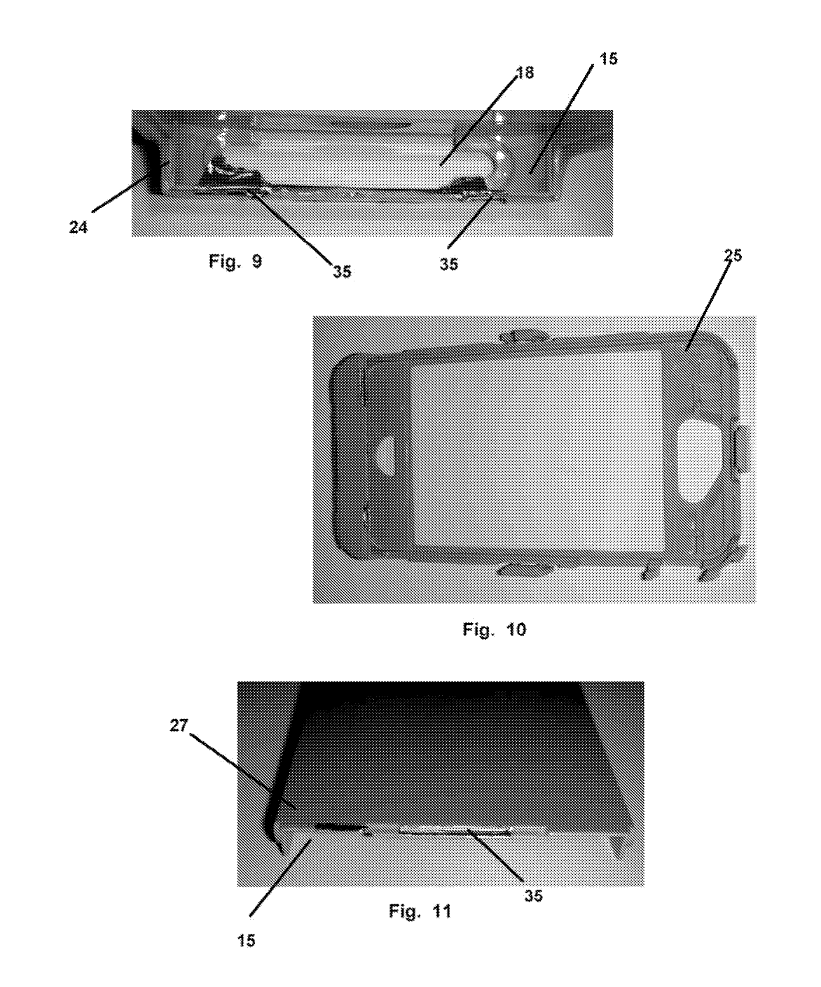

FIG. 9 is a depiction of a top-down view into an endwall of the formed case 12 showing an antenna element 18 at the endwall, positioned for a registered engagement with the phone inserted within the interior cavity 15. So positioned, antenna leads 35 are positioned to operatively connect for a direct hardwire connection with an antenna lead or element from the smartphones to which it engages. The case 12 for this mode of connection must be formed to have an interior cavity 15 which abuts and places the walls of the surrounded smartphone or pad computer or the like, in position to allow the leads 35 to engaged.

FIG. 10 shows a rear side of a front panel 25 which engages a rear panel to form the case 12. The front panel is configured to contact the video display side of a smart phone, or pad computer or the like, such as the IPHONE when operatively engaged.

FIG. 11 shows a bottom edge of a rear cover component of FIG. 9, ready for engagement to the front panel component to form a case 12. As shown this rear cover component is formed for a registered engagement in contact with the rear of a smartphone or pad computer and having an edge surface in communication with an interior mounted antenna element. As depicted, the lead 15 is in a position that will register with the edge surface of the device surrounded by the case 12, and achieve direct contact communication with the OEM antenna infernal positioned in the smartphone, such as the IPHONE.

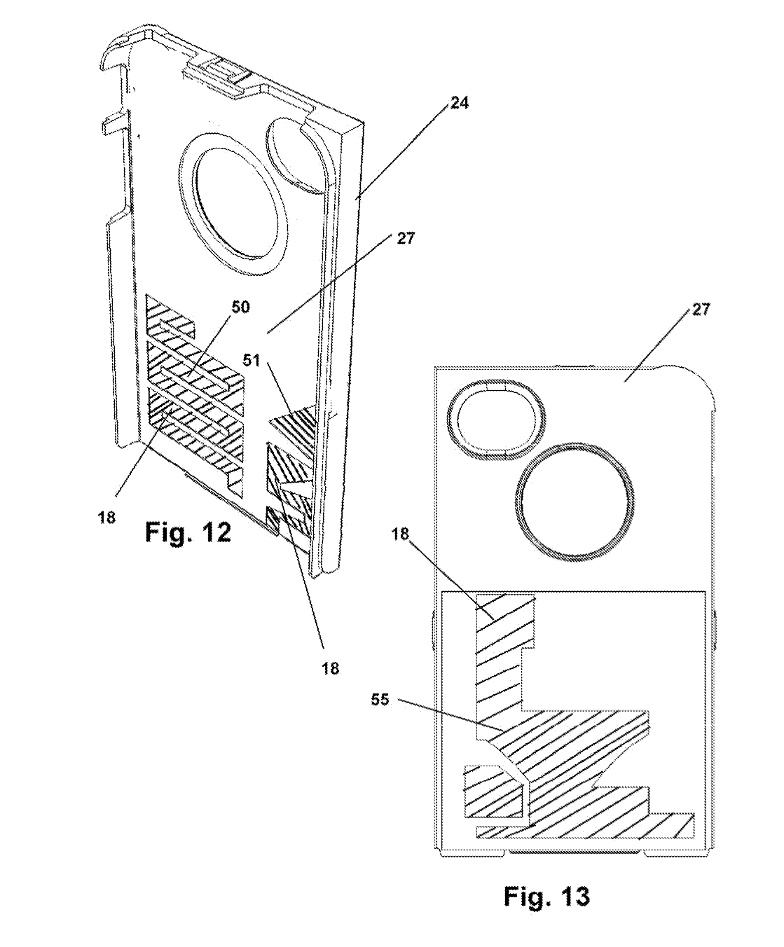

FIG. 12 depicts an inner surface of a rear component 24 of the case 12 which co-operatively engages a front component 25 as shown in FIG. 1a, and forms a smartphone, or pad computer, or portable electronic device, surrounding case 12. As depicted, the rear component 24 of the case 12 has a rearwall 27, on which has a plurality of antennas 18 are positioned on or adjacent to the interior surface of the rearwall 27. The antennas 18 are positioned in registered positions with the interior antennas of the surrounded phone or pad computer, to yield an optimum coupled electronic engagement and communication with the phone OEM antenna. Electronic probing with RF strength sensors, or oscilloscope engaged sensors, can ascertain the interior positions of a smartphone's feedlines and antennas to determine where on the case 12 an auxiliary antenna 18 must be in a registered position relative to the smartphone or pad antennas, to achieve a wireless coupled electronic engagement which is optimum. The shape of the auxiliary antenna 18 is most important to yield the maximum signal strength as well as optimum bandwidth.

Shown in FIG. 12 is a favored auxiliary antenna 18 for coupled engagement in the form of a zig zag meanderline antenna 50. Adjacent the meanderline, and electrically coupled therewith, is a second meanderline 51 with triangular portions having gaps facing the first meanderline 50. The second meanderline 51 can also be provided a feedline 35 for a direct wired communication on phones using their metal case for antennas.

FIG. 13 depicts the opposite side surface of the rear wall 27 on the exterior facing surface, of the rear component 24 shown in FIG. 12 and 1a. This depiction shows a particularly preferred mode of the device 10 which employs a plurality of auxiliary antennas 18 in a stacked configuration with each other through dialectic material or the material forming the rear component 24. The additional auxiliary antenna 18 on or adjacent thereto and are spaced from the internally positioned antennas 50 and 51 by a dialectic material forming the rear component to maximize RF signal transmission and to beam steer the RF signal away from the user's head, and toward multiple cell towers to maximize reception and transmission of phone and data. The current preferred stacked exterior antenna 55 works well in combination with the stacked antennas 50 and 51. It is shaped like a silhouette of a chair having steps in front, and a loose part in the rear and works well to send and receive all RF bands noted herein to and from the housed smartphone or pad computer in conjunction with the stacked antennas 50 and 51.

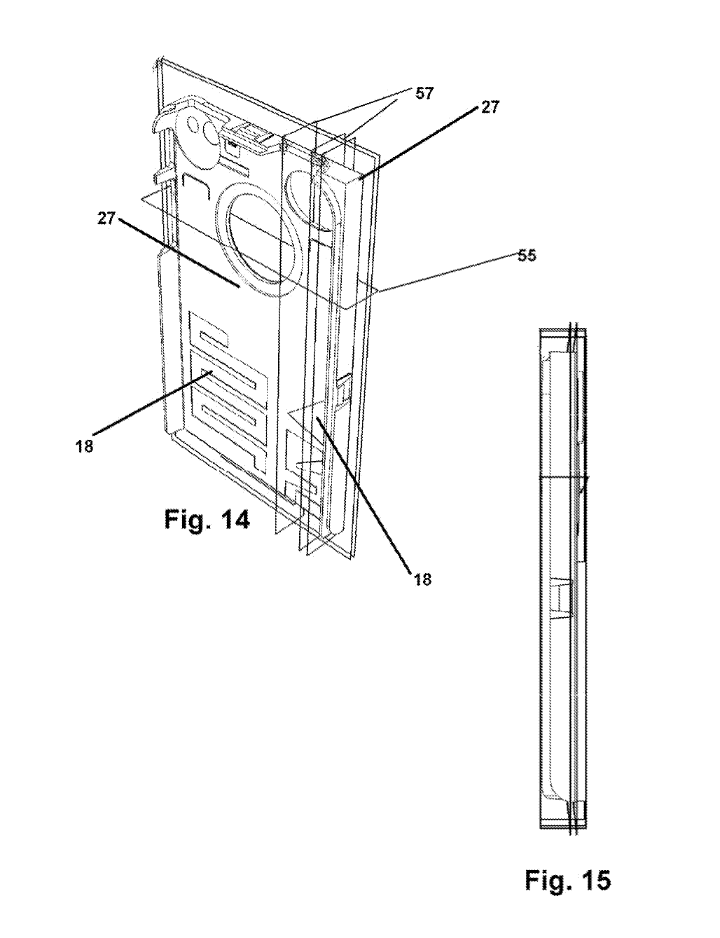

FIG. 14 depicts another view of the rear component of FIG. 12 showing the spacing 55 for the planes occupied by the stacked antennas in their registered spaced positioning to interact with the internal antenna and each other. Also shown are vertical disposed planes 57 calculated for optimum positioning of one antenna to communicate with internal phone antennas.

FIG. 15 is a side view of the device 10 in FIG. 14 showing planes occupied by auxiliary antennas in the stacked configuration, relative to each other, calculated for maximum electronic communication between OEM phone mounted antennas and the rear component engaged antenna or antennas.

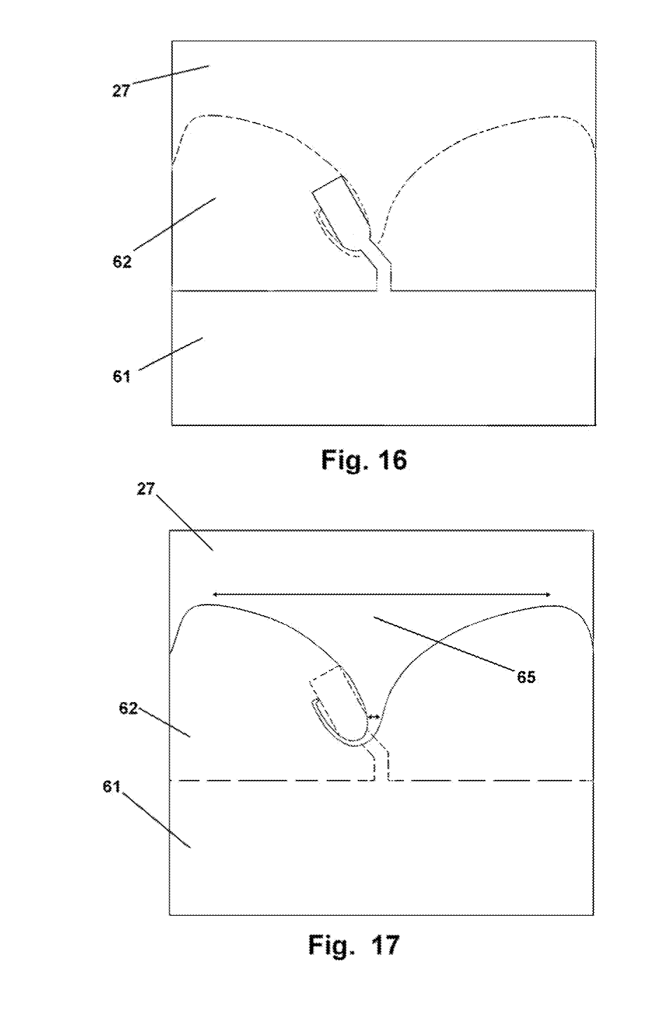

FIGS. 16-17 depict the rear wall 27 of the rear component 24 and show a stacked positioning of two antennas with a first antenna 61 closer to the rear surface of the engaged smartphone or pad, and a second antenna coupled thereto, closer to the exterior of the case 12 and further from the smartphone in a stacked configuration with a dialectic therebetween.

This is an especially preferred mode of the device 10 herein as it includes a wideband antenna 62 coupled to the first antenna 61 in a symbiotic or coupled relationship. Both antennas are spaced with a dialectic material at a calculated width to maximize the coupling and RF transmission. The wideband antenna 62 with a narrowing slot 65 between two lobes 67 will work in both horizontal, and vertical dispositions, as well as at angles, to receive and transmit in all frequencies between a highest defined by the narrowest point of the slot 65 and a lowest frequency determined by the widest point of the slot 65. Opposing descending edges on opposite sides of the lobes 67 have been shown to improve low frequencies near the maximum defined at the widest point of the slot. Thus the engaged electronic device will have wideband transmission and receive capabilities on all frequencies in the range, no matter what direction the phone is pointing since the wideband antenna 62 works horizontally, vertically, or angled, just as well.

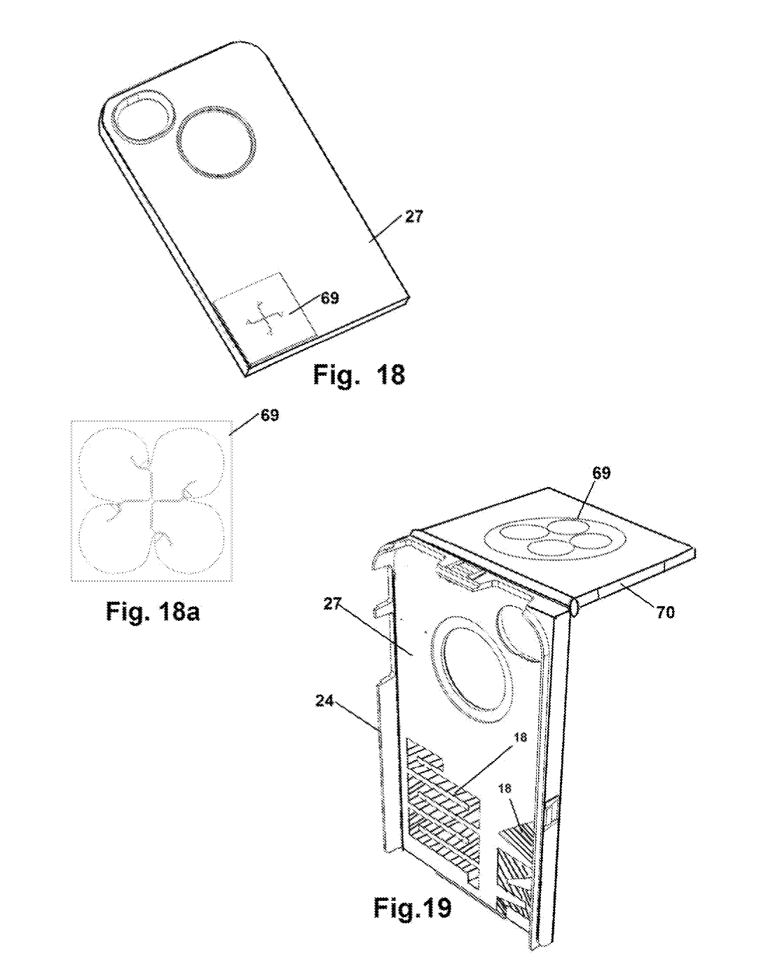

FIG. 18 shows the exterior or rear surface of the rear wall 27 of the rear component 24 as in FIG. 13 and showing a particularly preferred mode where an omnidirectional wideband antenna 69 is positioned in a stacked engagement with intermediate antennas and communicates RF signals, from omnidirectional sources, through the dialectic of the rear component 24 to one, or a plurality of stacked positioned interior antennas, such as 61, as described herein. As shown in FIG. 18a, the omnidirectional capability of the four slots of the foul lobed clover leaf shaped antenna, will provide an RF signal from and two all directions from the user.

FIG. 19 depicts a flip-up configured omni directional antenna 69 of FIG. 18. It or another antenna may be configured to receive and transmit on frequencies of low earth orbit satellites, such as 1616 and 1626.5 MHZ, which provides communication with IRIDIUM. A signal amplifier 70 with its own battery power can be provided to boost the signal on the trip to the satellite. In this mode of the device 10, an engaged smartphone or pad computer, would be provided satellite communication ability, without an original antenna for such. Reception and transmission may be enabled by a USB engaged receiver, or which a firmware upgrade to implant a virtual transceiver in the phone software, since many such devices synthesize the RF receiver with software. The satellite signal is fed from the horizontal antenna 69 using a feedline to an electronic communication with other antennas engaged with the rear wall 27 which communicate with the phone interior antenna.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. An auxiliary antenna for connection to a portable electronic device such as a smartphone, pad computer, or other portable electronic device, comprising:
an case, said case having an interior cavity in operative engagement with an exterior of an electronic device capable of electronic wireless communication;
said case having a front wall adapted for positioning a video screen of said electronic device therein;
said case having a rear wall on an opposite side of said cavity from said front wall;
a first auxiliary antenna, in an attachment with said rear wall at a mounted position;
said mounted position on said rear wall, calculated to place said auxiliary antenna in an RF communication with an internal antenna of said electronic device; and
said RF communication from said first auxiliary antenna, providing an RF signal of increased strength to said internal antenna and thereby to said electronic device.

2. The auxiliary antenna of claim 1, additionally comprising:
said attachment to said rear wall of said auxiliary antenna being a positioning with the material forming said rear wall between an interior facing surface and exterior facing surface of said rear wall.

3. The auxiliary antenna of claim 1, additionally comprising:
a second auxiliary antenna, in an attachment with said rear wall;
said second auxiliary antenna aligned with said first auxiliary antenna, to maximize RF coupling therebetween;
said RF signal of increased strength to said electronic device communicated from said second auxiliary antenna, through a coupling with said first auxiliary antenna and then to said internal antenna from said first auxiliary antenna.

4. The auxiliary antenna of claim 2, additionally comprising:
a second auxiliary antenna, in an attachment with said rear wall;
said second auxiliary antenna aligned with said first auxiliary antenna, to maximize RF coupling therebetween;
said increased RF signal strength to said electronic device communicated from said second auxiliary antenna, through a coupling with said first auxiliary antenna and then to said internal antenna from said first auxiliary antenna.

5. The auxiliary antenna of claim 3, additionally comprising:
said second auxiliary antenna being a wideband antenna;
said wideband antenna dimensioned to operate in a horizontal or vertical position with continuous reception and transmission across a bandwidth between a highest frequency and a lowest frequency;
said wideband antenna having a decreasing slot area formed between two conducting lobes;
a widest point of said decreasing slot, determining a lowest frequency communicated in said RF coupling; and
a narrowest point of said decreasing slot determining a highest frequency communicated in said RF Coupling.

6. The auxiliary antenna of claim 4, additionally comprising:
said second auxiliary antenna being a wideband antenna;
said wideband antenna dimensioned to operate in a horizontal or vertical position with continuous reception and transmission across a bandwidth between a highest frequency and a lowest frequency;
said wideband antenna having a decreasing slot area formed between two conducting lobes;
a widest point of said decreasing slot, determining a lowest frequency communicated in said RF coupling; and
a narrowest point of said decreasing slot determining a highest frequency communicated in said RF Coupling.

7. The auxiliary antenna of claim 5, additionally comprising:
said second auxiliary antenna being an omni directional wideband antenna, shaped like a four leaf clover when viewed from overhead; and
said omni directional wideband antenna communicating RF signal to and from said electronic device in an omnidirectional pattern.

8. The auxiliary antenna of claim 6, additionally comprising:
said second auxiliary antenna being an omni directional wideband antenna, shaped like a four leaf clover when viewed from overhead; and
said omni directional wideband antenna communicating RF signal to and from said electronic device in an omnidirectional pattern.

9. The auxiliary antenna of claim 7, additionally comprising:
said omni directional wideband antenna hinged to said case and rotatable from a vertical disposition parallel to a rear surface of said case, to a horizontal disposition, normal to said rear surface of said case;
a portion of said bandwidth between said highest frequency and said lowest frequency being in a frequency range of low earth orbiting satellites; and
said electronic device being a cellular telephone, whereby said omnidirectional wideband antenna communicates RF signals between said satellites and said cellular phone.

10. The auxiliary antenna of claim 8, additionally comprising:
said omni directional wideband antenna hinged to said case and rotatable from a vertical disposition parallel to a rear surface of said case, to a horizontal disposition, normal to said rear surface of said case;
a portion of said bandwidth between said highest frequency and said lowest frequency being in a frequency range of low earth orbiting satellites; and
said electronic device being a cellular telephone, whereby said omnidirectional wideband antenna communicates RF signals between said satellites and said cellular phone.
